(19) United States
(12) Patent Application Publication
(10) Pub. No.: US 2023/0087519 A1
(43) Pub. Date: Mar. 23, 2023

(54) HEATING CONDUCTIVE WIRE-LIKE ELEMENT

(71) Applicant: NV BEKAERT SA, Zwevegem (BE)

(72) Inventors: Dominique ANDRIES, Oudenaarde (BE); Marjolein VAN CAMPE, Lovendegem (BE)

(73) Assignee: NV BEKAERT SA, Zwevegem (BE)

(21) Appl. No.: 17/790,271

(22) PCT Filed: Mar. 3, 2021
(86) PCT No.: PCT/EP2021/055265

§ 371 Date: Jun. 30, 2022

(30) Foreign Application Priority Data
Mar. 5, 2020 (EP) 20161121.7

(51) Int. Cl. H05B 3/56

(52) U.S. Cl. CPC H05B 3/56; H05B 2203/017; H05B 2203/029

(57) ABSTRACT

The invention provides a heating conductive wire-like element comprising a core made from synthetic fibers a plurality of heating conductive wires around said core. The core is twisted in a predetermined direction X and the plurality of heating conductive wires are wound in a predetermined direction Y. The predetermined direction X is different from the predetermined direction Y. A predetermined number of said heating conductive wires are individually covered with a non- electrically conductive material.

### TECHNICAL FIELD

The invention relates to the field of flexible heating elements, e.g. vehicle (e.g. car) seat heating elements that comprise electrical heating cables.

### BACKGROUND ART

Electrical heating cables comprising metallic filaments (e.g. 15-150 metallic filaments) are known and are used in seat heating in cars. Each of the metallic filaments may have a diameter that is of a magnitude of about 50 μm. Car seat heating can be achieved by installing the electrical heating cables in the seats, e.g. in the form of one or more loops, to form a car seat heating element. In the car seat heating element, such a heating cable is connected to a power feeding unit that delivers current, whereby the element can be heated to a suitable temperature.

An important requirement among the requirements for vehicle seat heating systems is a long lifetime during which the car seat heating system is operating correctly and reliably.

In car seat heating elements or systems, electrical heating cables are subjected to dynamic bending forces. Hence, the flex life (resistance to dynamic bending) is an important parameter for the durability and lifetime of the heating cable and hence of the car seat heating element or system. A way to increase the flex life or flex endurance of a heating cable and consequently of the car seat heating element up to the required level, is the use in the heating cable of metallic filaments with lower diameter. However, decreasing the diameter of the metallic filaments exponentially increases the production costs of the heating cable and of the car seat heating element.

When individual metallic filaments of the heating cable of the car seat heating element are damaged or broken, it can lead to a local difference in electrical properties over the length of the heating cable. A so-called hot-spot can occur: at the position of the broken filament(s), the heat generation is higher than along the rest of the length of the heating cable. Hot-spots are to be avoided as they create a safety hazard. WO 01/058315—relating to a device for heating a component in a vehicle environment—describes a way to resolve the hot-spot formation which occurs at the interruption (breakage) of part of the metallic filaments of the heating cable. The solution provides a heating cable constructed from a number of strands of which a predetermined number of strands are individually electrically insulated with an insulating lacquer layer.

Although individual insulation of the strands or of the metallic filaments by means of lacquering is an effective way to solve hot-spot formation, the individual lacquering or individual coating of the strands or of the metallic filaments of the heating cable has a serious drawback in that it is technically very difficult to apply a uniform and effective lacquer on fine metallic filaments or strands. If the lacquer layer is not applied uniformly nor dried and cured correctly, bending of the heating cable during its use can damage the lacquer layer, resulting in lower lifetime of the heating cable or in insufficient prevention of hot-spots.

In order to protect the metallic filaments from corrosion (and especially from galvanic corrosion) and to increase the flex life of heating cables to the required levels for car seat heating applications, the heating cable of the car seat heating element can be provided with a polymer sheath. For the best values of flex life, high grade polymer coatings are required. These high grade polymer coatings (e.g. perfluoroalkoxy polymer, PFA) have the drawback that they are expensive and difficult to apply.

### DISCLOSURE OF THE INVENTION

It is an objective of the invention to provide a heating conductive wire-like element, in particular valid for automotive interior heating applications, e.g. for car seat heating, heating panels arm rest and head rest et al., that has a long lifetime during which it is functioning correctly and reliably (including that it has excellent flex life and effective hot-spot prevention) and which is easy to manufacture.

According to the present invention, it is provided a heating conductive wire-like element comprising a core made from synthetic fibers and a plurality of heating conductive wires around said core. The core is twisted in a predetermined direction X and the plurality of heating conductive wires are wound in a predetermined direction Y. The predetermined direction X is different from the predetermined direction Y. A predetermined number of said heating conductive wires are individually covered with a non-electrically conductive material. For example, the predetermined direction X is S-direction and the predetermined direction Y is Z-direction. As another example, the predetermined direction X is Z-direction and the predetermined direction Y is S-direction. In this way, the “S” and “Z” torque of the heating conductive wire-like element is balanced and therefore the heating conductive wire-like element is non-rotating.

The core element is preferably a rope made of synthetic yarns, e.g. of aromatic polyester fiber. The core according to the present invention has a twisted construction. The core can be a strand made up from yarns of synthetic fibers. Synthetic yarns that may be used as the core according to the invention include all yarns, which are known for their use in fully synthetic ropes. Such yarns may include yarns made of fibers of polypropylene, nylon, polyester. Preferably, yarns of high modulus fibers are used, for example yarns of fibers of liquid crystal polymer (LCP), aramid such as poly(p-phenylene terephthalamide) (known as Kevlar®), high molecular weight polyethylene (HMwPE), ultra-high molecular weight polyethylene (UHMwPE) such as Dyneema®, PBO (poly(p-phenylene-2,6-benzobisoxazole), and aromatic polyester (known as Vectran®). As a core, as an example, a monofilament, a multifilament or a spun of inorganic fibers such as a glass fiber or organic fibers such as a polyester fiber (e.g. polyethylene terephthalate), an aliphatic polyamide fiber, an aromatic polyamide fiber and a wholly aromatic polyester fiber can be used. In addition, a combination of the above described fibers can be also used.

The core is twisted and preferably has a pitch length in a range from 2 to 25 mm, preferably from 2 to 20 mm, more preferably from 2 to 15 mm, and most preferably from 5 to 15 mm. If the pitch length is too big, pushing on the core strand opens virtually holes in the center when the core is not fully covered by heating conductive wires. If the pitch length is too small, there is no room for any opening at all in the center as the strand is jammed, but the core stand would become hard and lose its flexibility, which is not desirable for a flexible heating element.

Regarding the heating conductive wires, conventionally known materials can be used. For example, a copper wire, a copper alloy wire, a nickel wire, an iron wire, an aluminum wire, a nickel-chromium alloy wire, an iron-chromium alloy wire can be used. When heating element with higher resistance is requested, stainless steel wire or copper cladded steel wire may be applied. As the copper alloy wire, for example, a tin-copper alloy wire, copper-nickel alloy wire, and a silver containing copper alloy wire can be used. From the above listed materials, the copper wire and the copper alloy wire are preferred to be used in the viewpoint of a balance between the cost and characteristics. Regarding the copper wire and the copper alloy wire, although both soft and hard materials can be used, semi-hard material is more preferable than the soft and hard material in the viewpoint of bending resistance.

The plurality of heating conductive wires are wound around the core in a helix. When winding the heating conductive wires around a core in a state of being paralleled together or twisted together, the paralleled state is more preferable than the twisted state. This is because the diameter of heating conductive element becomes smaller and a surface becomes smooth. In addition to the paralleled state and the twisted state, the conductive wires can be braided on the core material. The number of heating conductive wires and lay length of winding or twisting depend on the required resistance. Preferably, the plurality of heating conductive wires are covering at least 25% of the surface of the core. More preferably, the plurality of heating conductive wires are covering at least 50% of the surface of the core. As an example, the plurality of heating conductive wires are covering 100% of the surface of the core. In such case, the heating element provides biggest electrical conductivity. On the other hand, the twisted core is well protected and opening of the core is avoided.

According to the invention, said heating conductive wires are individually covered with a non-electrically conductive material. A non-electrically conductive coating can be made by applying varnish and drying it. A predetermined number of said heating conductive wires can be individually lacquered with a resin. Alternatively and preferably, said predetermined number of said heating conductive wires are individually wrapped with one or more non-electrically conductive filaments or individually wrapped with non-electrically conductive fibers or individually wrapped with one or more non-electrically conductive tapes. Although any non-electrically conductive filaments, fibers or tapes can in principle be used to wrap the metallic filaments, examples of preferred filaments are polyester, polyurethane, polyamide, fiberglass, polybenzobisoxazole (PBO), aram id, polypropylene, polyethylene, melt yarn, bicomponent fibers, bicomponent filaments (preferably of the type with a sheath with a lower melting temperature), or Polytetrafluoroethylene (PTFE). High tenacity polyester filaments are more preferred as their higher tensile strength results in an even more pronounced increase in flex life of the heating cable. Filaments for wrapping are preferably having a diameter between 12 and 70 micrometer. Fibers of discrete length can also be used to wrap the metallic filaments, examples are natural fibers (e.g. cotton) or synthetic fibers (polyester, polyamide, polypropylene, polyethylene et al.). In this aspect, the wrapping material and method can be referred to European patent EP2761977 B1, the content of which is integrated herewith into the disclosure of the present invention by explicit reference.

In addition, an insulation jacket layer can be formed on an outer periphery of the heating conductive wires. The insulation jacket layer is preferably formed on an outer periphery of the conductive wires. If, by any chance, the heating conductive wires are disconnected, power supply to other members are insulated by the insulation jacket layer. Furthermore, even when the spark occurs, generated heat of high temperature is insulated. When forming the insulation jacket layer, the method of forming is not particularly limited. Preferably, an extrusion molding can be used. If the insulation jacket layer is formed by the extrusion molding, a position of the heating conductive wires is fixed. Since friction and bending caused by displacement of the position of the conductive wires can be prevented, bending resistance is improved. Materials forming the insulation jacket layer comprises various resins such as a polyolefin-based resin, a polyester-based resin, a polyurethane-based resin, aromatic polyamide-based resin, an aliphatic polyamide-based resin, a vinyl chloride resin, a modified-Noryl resin (polyphenylene oxide resin), a nylon resin, a polystyrene resin, a fluororesin, a synthetic rubber, a fluororubber, an ethylene-based thermoplastic elastomer, an urethane-based thermoplastic elastomer, a styrene-based thermoplastic elastomer, and a polyester-based thermoplastic elastomer. In particular, a polymer composition having flame retardancy is preferably used. As for the flame retardant material, metal hydrates such as a magnesium hydroxide and an aluminum hydroxide, an antimony oxide, a melamine compound, a phosphorus compound, chlorine-based flame retardant, and a bromine-based flame retardant can be used. PFA coatings for instance, exist in different grades, the grades with higher temperature stability result in higher flex life contribution, but are more expensive in material cost and in applying the coating. A Perfluoroalkoxy (PFA) grade with temperature stability of 260° C. is much more expensive than a PFA grade with 225° C. temperature stability and needs higher temperature during the application process. Thanks to the presence of individually insulated conductive wires, the polymeric coating can be a lower grade or cheaper coating (e.g. polyamide 12 or TPE): high grade coatings contribute to the flex life of the heating cable, contribution of which is less or not required in heating cables according to the invention as the twisted synthetic core is in itself creating flex life of the heating conductive wire-like element.

A predetermined number of the heating conductive wires are individually covered with a non-electrically conductive material. Preferably, all the heating conductive wires are individually covered with a non-electrically conductive material. As another example, the heating conductive wires can be formed by alternatively arranging the conductive wires covered with the insulating layer and the conductive wires not covered with the insulating layer.

A heating conductive wire-like element of the invention can have an electrical resistance in a range of 0.2 to 1000 Ohm/meter. In specific cases, the heating conductive wire-like element can have an electrical resistance in a range of 0.2 to 3 Ohm/meter. The invention is of particular interest for vehicle seat heating element that comprise heating cables with a resistance below 1 Ohm/meter (measured at 20° C.) and still even more for heating cables with resistance below 0.75 Ohm/meter (measured at 20° C.).

The diameter of the heating conductive wire-like element is in a range of 0.1 to 1 millimeter, preferably in a range of 0.3 to 1 millimeter and more preferably in a range of 0.5 to 0.8 millimeter. Where diameter is mentioned, it is meant as equivalent diameter, which is for a non-round cross section the diameter of a circle having the same surface as the non-round cross section.

According to the second aspect of the present invention, it is provided a method of producing a heating conductive wire-like element, comprising the steps of (a) pre-twising a core made from synthetic fibers in a predetermined direction X, preferably said pre-twisted core having a pitch length in a range of 2 to 25 mm, (b) winding a plurality of heating conductive wires around said pre-twisted core in a predetermined direction Y, preferably with a pitch of 0.1 to 10 mm. Wherein, said predetermined direction X is different from said predetermined direction Y. For example, the predetermined direction X is S-direction and the predetermined direction Y is Z-direction. As another example, the predetermined direction X is Z-direction and the predetermined direction Y is S-direction. A predetermined number of said heating conductive wires are individually covered with a non-electrically conductive material. Preferably, said plurality of heating conductive wires are in a state of being paralleled together.

The long lifetime of flexible heating conductive wire-like element of the invention for automotive interior heating applications, e.g. for seat heating, heating panels arm rest and head rest et al., during which it is functioning correctly and reliably is obtained by the synergetic effects of preventing the occurrence of hot spots and by an increase in the flex fatigue resistance. The formation of hot-spots is effectively prevented by the insulation of heating conductive wires. On the other hand, surprisingly, the twisted fiber core results in a significant increase of the flex fatigue resistance, resulting in a longer lifetime during which the flexible heating element is functioning correctly.

### BRIEF DESCRIPTION OF FIGURES IN THE DRAWINGS

FIG. 1 shows an example of the cross-section of a heating conductive wire-like element according to the invention.

FIG. 2 shows an example of a longitudinal view of a heating conductive wire-like element according to the invention.

FIG. 3 shows another example of a longitudinal view of a heating cable according to the invention.

### MODE(S) FOR CARRYING OUT THE INVENTION

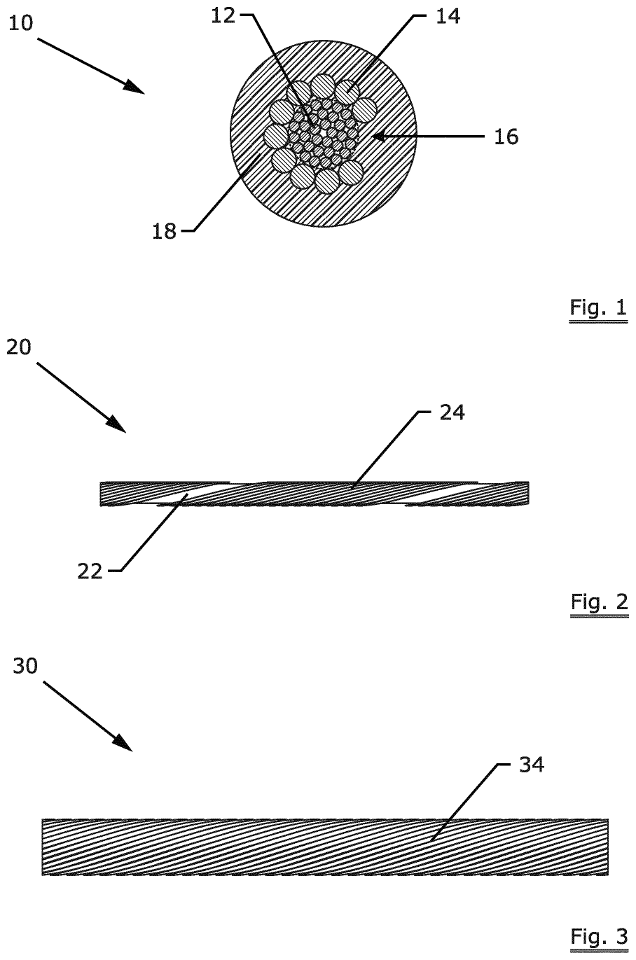

FIG. 1 shows the cross-section of a heating conductive wire-like element 10, that can be used as heating cable in the vehicle seat heating.

The configuration of the heating conductive wire-like element is illustrated in FIG. 1. A core strand 12 formed of fiber multi-filament bundle having an external diameter of 0.15 mm is provided. The core material is an aromatic polyester produced by the polycondensation of 4-hydroxybenzoic acid and 6-hydroxynaphthalene-2-carboxylic acid, e.g. commercially available Vectran®. The parallel non-twisted core is first pre-twisted at 300 twist/m in S- direction. Ten conductive wires 14, which are formed of a tin-containing copper alloy wire having a diameter of 0.12 mm, are spirally wound at 200 twist/m in a Z-direction around an outer periphery of the core strand 12 in a state of being paralleled together. The conductive wires 14 are individually lacquered with a non-electrically conductive material, e.g. a silicone resin with a thickness of about 8 pm by applying an alkyd silicone varnish and drying it. A heating conductive wire-like element 10 is formed by winding the conductive wires 14 around the core 12 with a gap 16 between two adjacent turns. As an example, the gap has a size similar to the diameter of the conductive wire. Then an extrusion covering of a polyamide 12 resin with a thickness of 0.25 mm is formed on the outer periphery of the wound conductive wires 14 as an insulation jacket layer 18. The heating conductive wire-like element 10 as described above has a finished cross-section of 0.12 mm² and an electrical resistance of about 0.5 Ohm/m.

In this embodiment, as shown in FIG. 2, the core 22 of the heating conductive wire-like element 20 is not fully covered. The conductive wires 24 is covering about 90 percent of the surface of the core. In a folding endurance test, the flex life of the heating conductive wire-like element 20 of this embodiment is about 40,000.

A similar sample is made for comparison, which has the same configuration except the core is made from parallel multi-filaments but not twisted. The flex life of the heating conductive wire-like element with parallel non-twisted fiber core is about 22,000.

As a second embodiment, the core (not visible in FIG. 3) is fully covered.

As shown in FIG. 3, the conductive wires 34 are fully covering the surface of the core. There were eleven conductive wires 34 in a parallel state winding around the core without distance between two adjacent turns. The flex life of this heating conductive wire-like element 30 of this second embodiment is comparable to the first embodiment but the heating conductive wire-like element with fully covered conductive wires has higher electrical conductivity.

The invention conductive wire-like element has significantly higher flex life.

A 45% higher flex life was obtained than the comparable conductive wire-like element without a twisted but parallel synthetic fibre core. The higher flex life is beneficial for dynamic applications, e.g. for vehicle seat heating. The experiments have shown that the vehicle seat heating that include the above heating conductive wire-like element have efficient hot-spot prevention and excellent flex life.

Elements and features of the different embodiments and examples can be combined while staying within the content and scope of the invention.

1. A heating conductive wire-like element, comprising a core made from synthetic fibers, being twisted in a predetermined direction X a plurality of heating conductive wires around said core, being wound in a predetermined direction Y, wherein said predetermined direction X is different from said predetermined direction Y, and wherein a predetermined number of said heating conductive wires are individually covered with a non-electrically conductive material.

2. The heating conductive wire-like element according to claim 1, wherein said predetermined direction X is S-direction and said predetermined direction Y is Z-direction.

3. The heating conductive wire-like element according to claim 1, wherein said predetermined direction X is Z-direction and said predetermined direction Y is S-direction.

4. The heating conductive wire-like element according to claim 1, wherein the pitch length of the twisted core is in a range from 2 to 25 mm, preferably from 2 to 20 mm, more preferably from 2 to 15 mm, and most preferably from 5 to 15 mm.

5. The heating conductive wire-like element according to claim 1, wherein said plurality of heating conductive wires are made from copper or copper alloy.

6. The heating conductive wire-like element according to claim 1, wherein said heating conductive wires are in a state of being paralleled together.

7. The heating conductive wire-like element according to claim 1, wherein said plurality of heating conductive wires are covering at least 50% of the surface of said core.

8. The heating conductive wire-like element according to claim 1, wherein said plurality of heating conductive wires are covering 100% of the surface of said core.

9. The heating conductive wire-like element according to claim 1, wherein said predetermined number of said heating conductive wires are individually lacquered with a resin.

10. The heating conductive wire-like element according to claim 1, wherein said predetermined number of said heating conductive wires are individually wrapped with one or more non-electrically conductive filaments or individually wrapped with non-electrically conductive fibers or individually wrapped with one or more non-electrically conductive tapes.

11. The heating conductive wire-like element according to claim 1, wherein an insulation jacket layer is formed on an outer periphery of the heating conductive wires.

12. The heating conductive wire-like element according to claim 1, wherein the electrical resistance of said heating conductive wire-like element is in a range of 0.2 to 1000 Ohm/meter.

13. The heating conductive wire-like element according to claim 1, wherein the diameter of the heating conductive wire-like element is in a range of 0.1 to 1 millimeter.

14. A method of producing a heating conductive wire-like element, comprising the steps of
(a) pre-twisting a core made from synthetic fibers in a predetermined direction X, preferably said pre-twisted core having a pitch length in a range of 2 to 25 mm,
(b) winding a plurality of heating conductive wires around said pre-twisted core in a predetermined direction Y, preferably with a pitch of 0.1 to 10 mm, wherein said predetermined direction X is different from said predetermined direction Y, and a predetermined number of said heating conductive wires are individually covered with a non-electrically conductive material.

15. The method of producing a heating conductive wire-like element according to claim 14, wherein said plurality of heating conductive wires are in a state of being paralleled together.
